(19) United States
(12) Patent Application Publication
(10) Pub. No.: US 2015/0296014 A1
(43) Pub. Date: Oct. 15, 2015

(54) PICTURE DOWNLOAD METHOD AND APPARATUS

(71) Applicant: Tencent Technology (Shenzhen) Company Limited, Shenzhen (CN)

(72) Inventor: Xiaofeng DENG, Shenzhen (CN)

(73) Assignee: Tencent Technology (Shenzhen) Company Limited

(21) Appl. No.: 14/750,142

(22) Filed: Jun. 25, 2015

Related U.S. Application Data
(63) Continuation of application No. PCT/CN2013/082924, filed on Sep. 4, 2013.

(30) Foreign Application Priority Data
Dec. 27, 2012 (CN) 201210578999.9

(51) Int. Cl. H04L 29/08; H04L 12/24

(52) U.S. Cl. CPC H04L 67/1095; H04L 41/0293; H04L 67/2833

(57) ABSTRACT

Embodiments of the present invention disclose a picture download method and apparatus, which are used to increase the speed of downloading multiple pictures at the same time. The method of the embodiments of the present invention includes: combining uniform resource locator (URL) addresses of multiple pictures, the multiple pictures including some or all of pictures to be downloaded; sending a download request to a proxy server, the download request carrying a combined URL address, to enable the proxy server to acquire the multiple pictures according to the combined URL address; and parsing a picture data flow that is obtained after the multiple pictures are combined and that is sent from the proxy server, to obtain the multiple pictures.

### RELATED APPLICATION

This application is a continuation application of PCT/CN2013/082924, filed on Sep. 4, 2013 and entitled “PICTURE DOWNLOAD METHOD AND DEVICE”, which claims priority to Chinese Patent Application No. 201210578999.9, filed on Dec. 27, 2012 to the State Intellectual Property Office of the People's Republic of China, and entitled “PICTURE DOWNLOAD METHOD AND APPARATUS”, which are hereby incorporated by reference in their entirety.

### FIELD OF THE TECHNOLOGY

The present disclosure relates to the technical field of communications.

### BACKGROUND OF THE DISCLOSURE

When a mobile terminal such as a mobile phone and a tablet computer is used to browse pictures, if there are multiple pictures on a same web page or interface to be downloaded, multiple non-persistent Hypertext Transfer Protocol (HTTP) connections are needed to extract the pictures. Therefore, the typical picture downloading method is time consuming due to many network links required.

### SUMMARY

Embodiments of the present invention provide a picture download method and apparatus, so as to solve the above problem.

The picture download method provided by an embodiment of the present invention includes:
combining uniform resource locator (URL) addresses of multiple pictures, the multiple pictures including some or all of pictures to be downloaded;
sending a download request to a proxy server, the download request carrying a combined URL address, to enable the proxy server to acquire the multiple pictures according to the combined URL address; and
parsing a picture data flow that is obtained after the multiple pictures are combined and that is sent from the proxy server, to obtain the multiple pictures.

The picture download apparatus provided by an embodiment of the present invention includes:
a combining unit, configured to combine URL addresses of multiple pictures, the multiple pictures including some or all of pictures to be downloaded;
a sending unit, configured to send a download request to a proxy server, the download request carrying a combined URL address, to enable the proxy server to acquire the multiple pictures according to the combined URL address; and
a parsing unit, configured to parse a picture data flow that is obtained after the multiple pictures are combined and that is sent from the proxy server, to obtain the multiple pictures.

A non-transient computer-readable storage medium provided by an embodiment of the present invention computer-executable instructions stored thereon, and these executable instructions run on a computer to execute the following steps:
combining URL addresses of multiple pictures, the multiple pictures including some or all of pictures to be downloaded;
sending a download request to a proxy server, the download request carrying a combined URL address, to enable the proxy server to acquire the multiple pictures according to the combined URL address; and
parsing a picture data flow that is obtained after the multiple pictures are combined and that is sent from the proxy server, to obtain the multiple pictures.

As can be seen from the above technical solutions, the embodiments of the present invention have the following advantages: URL addresses of some or all of the pictures to be downloaded are combined; a download request is sent to a proxy server, the download request carrying a combined URL address, to enable the proxy server to acquire the multiple pictures according to the combined URL address; and a picture data flow that is obtained after the multiple pictures are combined and that is sent from the proxy server is parsed, to obtain the multiple pictures. In such a manner, multiple pictures are downloaded at one time, thereby reducing time consumption of a network and increasing the speed of downloading pictures.

### BRIEF DESCRIPTION OF THE DRAWINGS

FIG. 1 is a schematic flowchart of a picture download method according to a first embodiment of the present invention;

FIG. 2 is a schematic flowchart of a picture download method according to a second embodiment of the present invention;

FIG. 3 is a schematic structural diagram of a picture download apparatus according to a third embodiment of the present invention;

FIG. 4 is a schematic structural diagram of a picture download apparatus according to a fourth embodiment of the present invention; and

FIG. 5 is a schematic structural diagram of a picture download apparatus according to a fifth embodiment of the present invention.

### DESCRIPTION OF EMBODIMENTS

The following further describes the technical solutions of the embodiments of the present invention with reference to the accompanying drawings and specific embodiments. Apparently, the described embodiments are only some of the embodiments of the present invention rather than all of the embodiments. All other embodiments obtained by a person skilled in the art based on the embodiments of the present invention without creative efforts, shall fall within the protection scope of the present disclosure.

In a first embodiment of the present invention, a mobile phone terminal is used as an example, and other mobile terminals are also applicable to the implementation process of the technical solution in this embodiment.

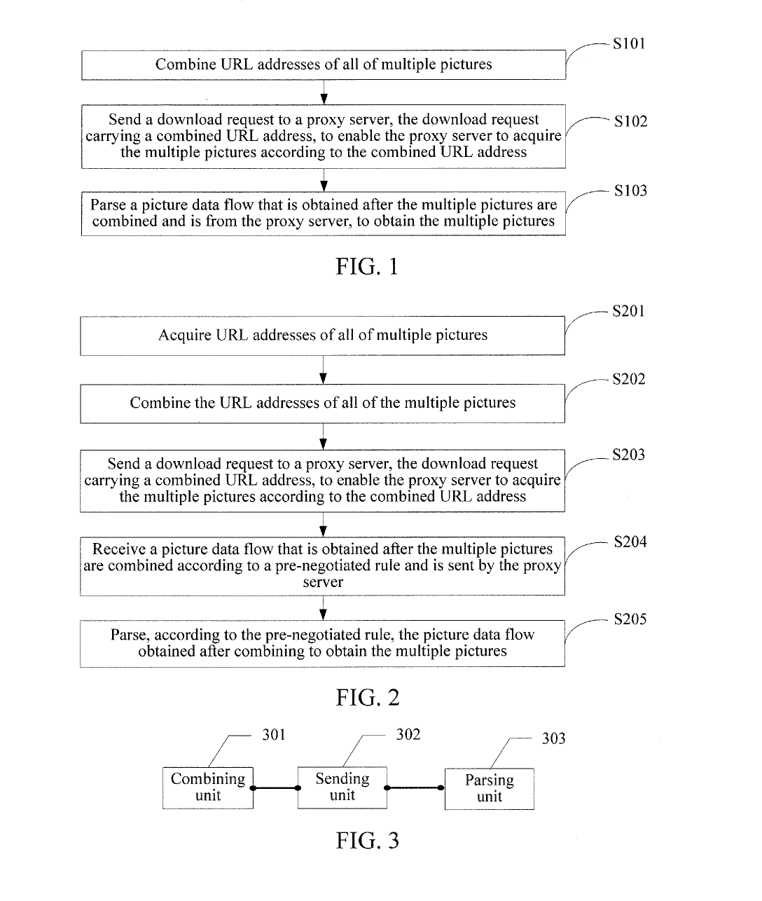

Referring to FIG. 1, the picture download method in this embodiment includes step 101 to step 103.

In step 101, URL addresses of all of multiple pictures are combined.

When a user browses a picture on the Internet by using a mobile phone terminal, if the user needs to download the picture, the user generally downloads the picture through a non-persistent HTTP connection. Therefore, in a typical method, when there are multiple pictures on a same web page or interface, multiple non-persistent connections are needed to extract the multiple pictures, which may cause time consumption in buffering of too many network links.

In this embodiment, the mobile phone terminal combines URL addresses of multiple pictures that include some or all of pictures a user selects to download. For example:

A URL address of a picture 1 is:
http://img1.gtimg.com/news/pics/hv1/184/217/1227/79841194.jpg;
a URL address of a picture 2 is:
http://mat1.gtimg.com/news/012xusong/shijie/piaojinhui/pjh178.jpg;
a URL address of a picture 3 is:
http://img1.gtimg.com/news/pics/hv1/54/202/1225/79707189.jpg; and
a URL address of a picture 4 is:
http://img1.gtimg.com/news/pics/hv1/90/27/1228/79857675.jpg;
therefore, a combined URL address is:
http://img1.gtimg.com/news/pics/hv1/184/217/1227/79841194.jpg|
   http://mat1.gtimg.com/news/012xusong/shijie/piaojinhui/pjh178.jpg|
   http://img1.gtimg.com/news/pics/hv1/54/202/1225/79707189.jpg|
   http://img1.gtimg.com/news/pics/hv1/90/27/1228/79857675.jpg.

In step 102, a download request is sent to a proxy server, the download request carrying a combined URL address, to enable the proxy server to acquire the multiple pictures according to the combined URL address.

In this embodiment, a mobile phone terminal sends a download request to a proxy server, where the download request is for requesting the proxy server to download multiple pictures that a user selects to download, and the download request carries a combined URL address, to enable the proxy server to acquire the multiple pictures according to the combined URL address.

In step 103, a picture data flow that is obtained after the multiple pictures are combined and that is sent from the proxy server is parsed, to obtain the multiple pictures.

In this embodiment, the proxy server acquires the multiple pictures according to the combined URL address sent by the mobile phone terminal, combines the multiple pictures into a picture data flow, and sends the picture data flow obtained after combining to the mobile phone terminal After receiving the picture data flow that is obtained after the multiple pictures are combined and that is sent by the proxy server, the mobile phone terminal parses the picture data flow obtained after combining to obtain the multiple pictures.

In this embodiment, a mobile phone terminal combines URL addresses of some or all of pictures to be downloaded, and sends a download request to a proxy server, the download request carrying a combined URL address, to enable the proxy server to acquire the multiple pictures according to the combined URL address. The mobile phone terminal receives a picture data flow that is obtained after the multiple pictures are combined and that is sent by the proxy server, and parses the picture data flow obtained after combining to obtain the multiple pictures, thereby achieving downloading of multiple pictures at one time, reducing time consumption of the network, and increasing the speed of downloading pictures.

A second embodiment of the present invention provides another picture download method. Referring to FIG. 2, the picture download method in this embodiment includes step 201 to step 205.

In step 201, URL addresses of multiple pictures are acquired, the multiple pictures including some or all of pictures to be downloaded.

That a mobile phone terminal acquires URL addresses of multiple pictures to be downloaded can be implemented by a module that is in the mobile phone terminal and has a function of acquiring a URL address of a picture. Software having a function of acquiring a URL address of a picture is stored in the module.

In step 202, the URL addresses of the multiple pictures are combined.

When a user browses a picture on the Internet by using a mobile phone terminal, if the user needs to download the picture, the user generally downloads the picture through a non-persistent HTTP connection. Therefore, in a typical method, when there are multiple pictures on a same web page or interface, multiple non-persistent connections are needed to extract the multiple pictures, which may cause time consumption in buffering of too many network links.

In this embodiment, that a mobile phone terminal combines URL addresses of all of multiple pictures that a user selects to download into one URL address can be implemented by a module that is in the mobile phone terminal and has a function of combining URL addresses of pictures. Software having a function of combining URL addresses of pictures is stored in the module.

The mobile phone terminal combines URL addresses of multiple pictures where the multiple pictures include some or all of pictures a user selects to download. For example:

A URL address of a picture 1 is:
http://img1.gtimg.com/news/pics/hv1/184/217/1227/79841194.jpg;
a URL address of a picture 2 is:
http://mat1.gtimg.com/news/012xusong/shijie/piaojinhui/pjh178.jpg;
a URL address of a picture 3 is:
http://img1.gtimg.com/news/pics/hv1/54/202/1225/79707189.jpg; and
a URL address of a picture 4 is:
http://img1.gtimg.com/news/pics/hv1/90/27/1228/79857675.jpg;
therefore, a combined URL address is:
http://img1.gtimg.com/news/pics/hv1/184/217/1227/79841194.jpg|
   http://mat1.gtimg.com/news/012xusong/shijie/piaojinhui/pjh178.jpg|
   http://img1.gtimg.com/news/pics/hv1/54/202/1225/79707189.jpg|
   http://img1.gtimg.com/news/pics/hv1/90/27/1228/79857675.jpg.

In step 203, a download request is sent to a proxy server, the download request carrying a combined URL address, to enable the proxy server to acquire the multiple pictures according to the combined URL address.

A mobile phone terminal sends a download request to a proxy server, where the download request is for requesting the proxy server to download multiple pictures that a user selects to download, and the download request carries a combined URL address, to enable the proxy server to acquire the multiple pictures according to the combined URL address.

In this embodiment, that the proxy server acquires the multiple pictures according to the combined URL address may be implemented in a multithreaded manner to acquire multiple pictures in parallel. A thread is a single sequential control flow in a program. Simultaneous running of multiple threads in a single program to complete different tasks is called multithreading.

In step 204, a picture data flow that is obtained after the multiple pictures are combined according to a pre-negotiated rule and sent by the proxy server is received.

A mobile phone terminal receives a picture data flow that is obtained after the multiple pictures are combined and is sent by the proxy server, where the multiple pictures may be combined by using rule a pre-negotiated between the mobile phone terminal and the proxy server.

The proxy server acquires the multiple pictures according to the combined URL address that is sent by the mobile phone terminal, and combines the multiple pictures into a picture data flow according to a rule that is pre-negotiated with the mobile phone terminal system, where the pre-negotiated rule is a rule that is pre-negotiated by the proxy server and the mobile phone terminal on how the proxy server combines multiple pictures into a picture data flow and how the mobile phone terminal parses the picture data flow to obtain data of each single picture among the multiple pictures.

In step 205, the picture data flow obtained after combining is parsed according to the pre-negotiated rule to obtain the multiple pictures.

The mobile phone terminal receives, from the proxy server, the picture data flow obtained after combining, and then parses, according to the pre-negotiated rule, the picture data flow obtained after combining to obtain the multiple pictures.

In this embodiment, a mobile phone terminal acquires URL addresses of multiple pictures where the multiple pictures include some or all of pictures to be downloaded, combines the acquired URL addresses, and sends a download request to a proxy server, the download request carrying a combined URL address, to enable the proxy server to acquire, according to the combined URL address, the multiple pictures in parallel in a multithreaded manner. The mobile phone terminal receives a picture data flow that is obtained after the multiple pictures are combined according to a pre-negotiated rule and that is sent by the proxy server, and parses, according to the pre-negotiated rule, the picture data flow obtained after combining to obtain the multiple pictures, thereby achieving downloading of multiple pictures at one time, reducing time consumption of the network, and increasing the speed of downloading pictures.

A third embodiment of the present invention provides a picture download apparatus. Referring to FIG. 3, the picture download apparatus in this embodiment includes:
a combining unit 301, configured to combine URL addresses of multiple pictures, the multiple pictures including some or all of pictures to be downloaded;
a sending unit 302, configured to send a download request to a proxy server, the download request carrying a URL address obtained after combining by the combining unit 301, to enable the proxy server to acquire the multiple pictures according to the combined URL address; and
a parsing unit 303, configured to parse a picture data flow that is obtained after the multiple pictures are combined and that is sent from the proxy server, to obtain the multiple pictures.

For the process of implementing respective functions by each unit of the picture download apparatus in this embodiment of the present invention, please refer to the specific description of the embodiment in FIG. 1 above. The details are not described herein again.

In this embodiment of the present invention, the combining unit 301 combines URL addresses of multiple pictures, the sending unit 302 sends a download request to a proxy server, the download request carrying a combined URL address, to enable the proxy server to acquire the multiple pictures according to the combined URL address, and the parsing unit 303 parses a picture data flow that is obtained after the multiple pictures are combined and that is sent from the proxy server, to obtain the multiple pictures, thereby achieving downloading of multiple pictures at one time, reducing time consumption of the network, and increasing the speed of downloading pictures.

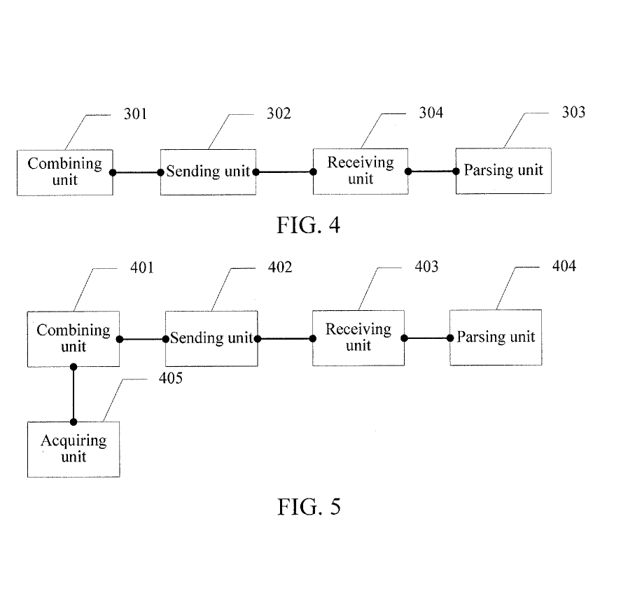

A fourth embodiment of the present invention provides another picture download apparatus. Referring to FIG. 4, compared with the third embodiment, the picture download apparatus provided by this embodiment further includes:
a receiving unit 304, configured to receive a picture data flow that is obtained after multiple pictures are combined and that is sent by the proxy server.

The parsing unit 303 can parse the picture data flow that is obtained after the multiple pictures are combined and that is received by the receiving unit 304, to obtain the multiple pictures.

A fifth embodiment of the present invention provides another picture download apparatus. Referring to FIG. 5, the picture download apparatus in this embodiment includes:
a combining unit 401, configured to combine URL addresses of multiple pictures, the multiple pictures including some or all of pictures to be downloaded;
a sending unit 402, configured to send a download request to a proxy server, the download request carrying a URL address obtained after combining by the combining unit 401, to enable the proxy server to acquire the multiple pictures according to the combined URL address;
a receiving unit 403, configured to receive a picture data flow that is obtained after the multiple pictures are combined and that is sent by the proxy server; and
a parsing unit 404, configured to parse the picture data flow that is obtained after combining and that is received by the receiving unit 403, to obtain the multiple pictures.

Further,
the picture data flow that is sent by the proxy server and that is received by the receiving unit 403 is obtained according to a pre-negotiated rule; and
the parsing unit 404 can further parse, according to the pre-negotiated rule, the picture data flow obtained after combining to obtain the multiple pictures.

It should be noted that, the picture download apparatus in this embodiment of the present invention may further include:
an acquiring unit 405, configured to acquire URL addresses of some or all of the multiple pictures to be downloaded.

For the process of implementing respective functions by each unit of the picture download apparatus in this embodiment of the present invention, please refer to the specific description of the embodiments in FIG. 1 and FIG. 2 above. The details are not described herein again.

In this embodiment, the acquiring unit 405 acquires URL addresses of multiple pictures, the combining unit 401 combines the acquired URL addresses, and the sending unit 402 sends a download request to a proxy server, the download request carrying a URL address obtained after combining by the combining unit 401, to enable the proxy server to acquire, according to the combined URL address, the multiple pictures in parallel in a multithreaded manner. The receiving unit 403 receives a picture data flow that is obtained after the multiple pictures are combined according to a pre-negotiated rule and is sent by the proxy server, and the parsing unit 404 parses, according to the pre-negotiated rule, the picture data flow obtained after combining to obtain the multiple pictures, thereby achieving downloading of multiple pictures at one time, reducing time consumption of the network, and increasing the speed of downloading pictures.

Additionally, the present disclosure further provides a program product having machine-readable instruction code stored therein. When the instruction code is read and executed by a processor, the picture download method of the foregoing embodiments of the present invention can be executed. Accordingly, various storage media such as a magnetic disk, an optical disc, a magneto-optical disk, and a semiconductor memory for carrying the program product also fall within the present disclosure.

The above mentioned machine-readable storage media include, but are not limited to, various memories and storage units, semiconductor devices, magnetic disk units such as optical discs, magnetic disks, and magneto-optical disks, as well as other media suitable for information storage.

The above description introduces the picture download method and apparatus provided by the present disclosure in detail. A person skilled in the art may make changes to the specific implementation manners and application scope based on the conception of the embodiments of the present invention. In conclusion, the content of this specification shall not be construed as a limitation to the present disclosure.

What is claimed is:

1. A picture download method, comprising:
combining, by a mobile terminal, uniform resource locator (URL) addresses of multiple pictures, the multiple pictures including at least some of pictures to be downloaded;
sending, by the mobile terminal, a download request to a proxy server, the download request carrying a combined URL address, to enable the proxy server to acquire the multiple pictures according to the combined URL address; and
parsing, by the mobile terminal, a picture data flow that is obtained after the multiple pictures are combined and that is sent from the proxy server, to obtain the multiple pictures.

2. The method according to claim 1, wherein the multiple pictures are acquired by the proxy server in parallel in a multithreaded manner.

3. The method according to claim 1, further comprising acquiring the URL addresses of the multiple pictures before the combining URL addresses of the multiple pictures.

4. The method according to claim 2, further comprising acquiring the URL addresses of the multiple pictures before the combining URL addresses of the multiple picture.

5. A picture download apparatus, comprising:
a processor and memory machine-readable instruction code stored therein, wherein the processor executes the code to comprise:
a combining unit that combines uniform resource locator (URL) addresses of multiple pictures, the multiple pictures including some or all of pictures to be downloaded;
a sending unit that sends a download request to a proxy server, the download request carrying a URL address obtained after combining by the combining unit, to enable the proxy server to acquire the multiple pictures according to the combined URL address; and
a parsing unit that parses , a picture data flow that is obtained after the multiple pictures are combined and that is sent from the proxy server, to obtain the multiple pictures.

6. The apparatus according to claim 5, further comprising:
a receiving unit that receives a picture data flow that is obtained after the multiple pictures are combined and that is sent by the proxy server.

7. The apparatus according to claim 5, further comprising:
an acquiring unit that acquires the URL addresses of the multiple pictures.

8. A non-transient computer-readable storage medium, having computer-executable instructions stored thereon, and these executable instructions run on a computer to execute the following steps:
combining uniform resource locator (URL) addresses of multiple pictures, the multiple pictures including some or all of pictures to be downloaded;
sending a download request to a proxy server, the download request carrying a combined URL address, to enable the proxy server to acquire the multiple pictures according to the combined URL address; and
parsing a picture data flow that is obtained after the multiple pictures are combined and that is sent from the proxy server, to obtain the multiple pictures.
